(19) United States
(12) Patent Application Publication
(10) Pub. No.: US 2026/0202608 A1
(43) Pub. Date: Jul. 16, 2026

(54) Spot Size Converter for Adapting the Diameter and/or the Shape of a Mode Field of an Optical Component and Method of Fabricating a Spot Size Converter

(71) Applicant: FRAUNHOFER-GESELLSCHAFT ZUR FÕRDERUNG DER ANGEWANDTEN FORSCHUNG E.V., Mûnchen (DE)

(72) Inventors: Patrick Runge, Berlin (DE); Gerrit Fiol, Berlin (DE)

(21) Appl. No.: 19/138,270

(22) PCT Filed: Dec. 12, 2023
(86) PCT No.: PCT/EP2023/085371

§ 371 Date: Jun. 12, 2025

(30) Foreign Application Priority Data
Dec. 13, 2022 (WO) PCT/EP2022/085698

(51) Int. Cl. G02B 6/12

(52) U.S. Cl. CPC G02B 6/12; G02B 2006/12152

(57) ABSTRACT

A spot size converter for adapting the diameter and/or the shape of a mode field of an optical component is provided. The spot size converter includes a substrate; an optical waveguide including at least one core layer and at least a first and a second cladding layer, wherein the first cladding layer is located between the substrate and the core layer, while the second cladding layer is arranged on a side of the core layer facing away from the first cladding layer; a first section in which the core layer has a first thickness; and a second section in which the core layer has a second thickness which is smaller than the first thickness. A ramp region is located between the first and the second section and in which the thickness of the core layer decreases continuously.

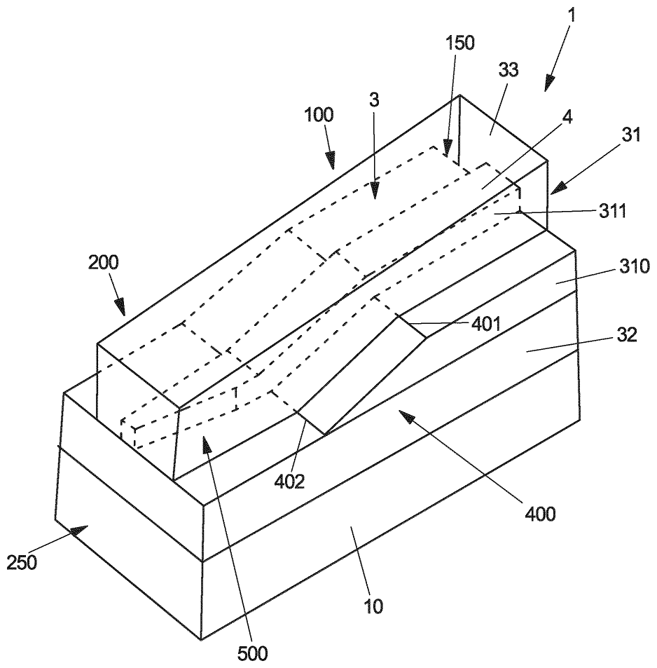

### CROSS-REFERENCE TO RELATED APPLICATIONS

This application is the United States national phase of International Patent Application No. PCT/EP2023/085371 filed Dec. 12, 2023, and claims priority to International Patent Application No. PCT/EP2022/085698 filed Dec. 13, 2022, the disclosures of each of which are hereby incorporated by reference in their entireties.

### BACKGROUND

### Technical Field

The present disclosure relates to a spot size converter for adapting the diameter and/or the shape of a mode field of an optical component and a method of fabricating a spot size converter.

### Technical Considerations

In thin film photonic integrated circuits (TF-PICs), optical waveguides have a buried oxide (BOX) cladding layer and a thin film waveguide core layer resulting in a strong vertical mode guiding as the refractive index of a BOX material typically is between 1.5 and the refractive index of the thin film waveguide core layer may be greater than 2. Typical thicknesses of the thin film waveguide core layer are below 1 μm. In addition, the mode guiding in horizontal direction (i.e., parallel to a substrate of the TF-PIC) is provided by structuring the TF-WL layer laterally. For example, the mode guiding in the horizontal direction is usually achieved by forming a waveguide rib (e.g., by means of an etch process), wherein the rib has a width of approximately 2 μm so that single-mode waveguiding is ensured. However, this configuration of the waveguide complicates the coupling between a TF-PIC and another optical device such as a glass fiber. The article Lingyan He, et al., “Low-loss fiber-to-chip interface for lithium niobate photonic integrated circuits,” Opt. Lett. 44, 2314-2317 (2019) describes a spot size converter to provide an interface between a TF-PIC and an optical fiber. The spot size converter is to adapt the optical mode field output by the PIC to the size of the mode field to the optical properties, e.g., the core diameter, of the optical fiber. However, the disclosed spot size converter may require tight fabrication tolerances.

### SUMMARY

It is an object of the present disclosure to facilitate the fabrication of a spot size converter.

According to the present disclosure, a spot size converter for adapting the diameter and/or the shape of a mode field of an optical component is provided, comprising
a substrate;
an optical waveguide comprising at least one core layer and at least a first and a second cladding layer, wherein
the first cladding layer is located between the substrate and the core layer and the second cladding layer is arranged on a side of the core layer facing away from the first cladding layer;
a first section in which the core layer has a first thickness;
a second section in which the core layer has a second thickness which is smaller than the first thickness; and
a ramp region located between the first and the second section and in which the thickness of the core layer decreases continuously.

The spot size converter according to the present disclosure may be used as an interface between a TF-PIC or a planar lightwave circuit—PLC and another optical device such as an optical fiber, a lens or another PIC. By means of the spot size converter, the optical mode of the TF-PIC may be transferred to a mode having a larger spot size corresponding to the size of an optical mode supported by the optical fiber. The continuous decrease of the core layer thickness may cause a continuous reduction of the vertical confinement of a mode guided by the waveguide such that the mode size (spot size) widens. The “thickness” of the core layer refers to the extension of the core layer in vertical direction, i.e., perpendicular to the substrate. Further, it should be noted that the ramp region does not necessarily comprise a linear ramp. The present disclosure is not restricted to a particular shape of the ramp region. The present disclosure may permit less tight fabrication tolerances and thus may permit using processes with lower resolution (employing, e.g., i-line steppers instead of deep UV steppers or e-beam processes).

The core layer of the optical waveguide may comprise a guiding structure configured to guide light laterally, i.e., the guiding structures provides confinement in a horizontal direction (parallel to the substrate).

For example, the guiding structure comprises or consists of a rib. The rib may be a structure having lateral sidewalls, wherein a material different from a material forming the core layer is present adjacent the lateral sidewalls (e.g., the material of the second cladding layer).

According to some non-limiting embodiments of the present disclosure, the spot size converter may comprise a region in which the width of the guiding structure decreases (e.g., continuously). The “width” refers to the extension of the guiding structure (e.g., the rib) in a direction parallel to the substrate. For example, the region in which the width of the guiding structure decreases overlaps at least partially with the ramp region. In other words, there may be a portion of the spot size converter in which both the thickness (height) of the core layer and the width of the guiding structure decreases. However, it is also possible that the ramp region (i.e., the vertically tapered region) and the region in which the width of the guiding structure decreases (the laterally tapered region) are arranged consecutively. For example, the ramp region and the region in which the width of the guiding structure decreases adjoin each other.

The width of the guiding structure may be at least essentially constant within the ramp region (i.e., within the vertically tapered region), while it decreases in a region of the spot size converter outside the ramp region. The width of the guiding structure may be constant across the entire ramp region or only a portion thereof. For example, the width of the guiding structure is at least essentially constant within the ramp region, while the width of the guiding structure decreases in a region between the ramp region and a first facet providing an interface to an optical device, e.g., an optical fiber. However, that does not necessarily mean that the guiding structure extends to the facet. Rather, the guiding structure (e.g., the rib) may not extend to the facet, as will be described below. A region having the decreasing width of the guiding structure (i.e., a laterally tapered region) may be arranged-as an alternative or in addition-on a side of the ramp region facing away from the first facet, e.g., between the ramp region (having constant width) and another side of the spot size converter (e.g., a second facet) or between the ramp region (having constant width) and optical component coupled to the spot sized converter. The optical component may be an integrated component (e.g., a PIC) and/or a component that is integrally coupled to the spot size converter.

The generation of the vertically tapered region (i.e., the ramp region) may be performed independently from the generation of the guiding structure (e.g., a rib) and e.g., independently from the generation of the laterally tapered region. For example, the process of forming the ramp region may be at least partially separate and independent from the process used for forming the guiding structure. For example, the ramp region is generated before the (e.g., laterally tapered) guiding structure, or vice versa. It is also possible that the ramp region and the guiding structure are at least partially produced simultaneously—using, however, separate and independent processes (e.g., separate etching processes). For example, the ramp region is fabricated using a first lithography process (e.g., gray-scale lithography). After the first lithography process, the ramp region may be generated using an etching process, e.g., a dry etching process. For the generation of the guiding structure, a second lithography process—different from the one used for the fabrication of the ramp region—is performed. After the second lithography process the guiding structure is formed, e.g., by means of an etching process. The formation of the guiding structure may be carried out before or after performing the process for producing the ramp region. Since both processes rely on two independent lithography processes, the slope of the ramp region can be varied independently from the width of the guiding structure at each position along the spot size converter.

Further, the shape of the guiding structure in the first section may be different from the shape of the guiding structure in the second section. The “shape” may refer to a contour in a cross section perpendicular to a main extension direction of the optical waveguide. For example, the guiding structure may have an essential rectangular shape in one of the sections and a non-rectangular shape in the other section.

The waveguide core layer may comprise an upper and a lower portion, the upper portion having the guiding structure formed therein, and the lower portion extending laterally beyond the lateral light guiding structure. For example, the lower portion forms a layer or a slab waveguiding structure. The upper portion may consist of the guiding structure. Further, the upper and a lower portion of the core layer may comprise or consist of the same material. The height of the guiding structure (e.g., the height of a rib) may be at least one third of the total thickness of the core layer, i.e., the sum of the thicknesses of the upper and lower portion. It is also possible that the guiding structure is formed by removing (e.g., etching) parts of the core layer adjacent the guiding structure completely such that the height of the guiding structure corresponds to the total thickness of the core layer. In this case, the core layer-at least in a region of the spot size converter, e.g., between the ramp region and the facet-thus consists of the guiding structure. For example, if the guiding structure is a rib, the core layer may have been completely removed adjacent the rib such that the thickness of the core layer corresponds to the height of the rib.

The total thickness of the core layer may be smaller than 1 μm. The width of the guiding structure (e.g., the width of the rib) may be approximately 2 μm or smaller (at least outside the region in which the width of the guiding structure decreases).

Furthermore, the decrease of the thickness of the core layer may affect mainly or only the lower layer, while the thickness (height) of the guiding structure (e.g., the rib) may be kept essentially constant. For example, the thickness of the lower portion may be reduced to essentially zero such that the core layer at the end of the ramp region consists of the guiding structure, only. However, generally the thickness of the upper and/or lower portion of the core layer may decrease over the ramp region.

According to some non-limiting embodiments of the present disclosure, the spot size converter comprises a facet via which light can be coupled into an optical device. The optical device may be an optical fiber, a lens or another PIC as already set forth above. The facet may be formed by a face of the spot size converter extending perpendicularly to the substrate and the optical waveguide. Anti-reflection coating can be applied to the facet.

For example, the guiding structure (e.g., the rib) does not extend to the facet. Thus, the lateral confinement provided by the optical waveguide may end in a distance from the facet. However, it is also possible the guiding structure extends up to the facet. For example, the region in which the width of the guiding structure decreases extends to the facet. In some non-limiting embodiments, the guiding structure has a portion located between the ramp region and the facet in which its width is essentially constant. For example, said portion may be located between the facet and the region in which the width of the guiding structure decreases.

The first and the second cladding layer each have a refractive index that is lower than the refractive index of the core layer. For example, the refractive indices of the first and the second cladding layer are essentially identical (e.g., the cladding layers are formed from the same material) or at least similar (deviating from one another by e.g., +−10 %). Alternatively, the refractive index of the second cladding layer may be in the range of −20 % of the refractive index of the first cladding layer and −10 % of the core layer refractive index. The first cladding layer may be formed by a buried oxide (BOX) layer. For example, the buried oxide layer comprises or consists of silicon oxide. The second cladding layer also comprises or consists of silicon oxide. The core layer may comprise or consist of lithium niobate or silicon nitride. The substrate may comprise or consist of silicon and/or silicon oxide.

The second cladding layer may at least partially embed the core layer. For example, the second cladding layer embeds the guiding structure, e.g., at least in the first section, the second section and/or the ramp region.

The region in which the thickness of the core layer decreases continuously may have a minimum length (along the optical waveguide) of 5 μm or 10 μm and/or a maximum length of 200 μm, 300 μm or 400 μm.

Further, the ramp region may have a first end (in proximity or adjacent the first section) and a second end (in proximity or adjacent the second section), wherein the thickness of the core layer at the first end is larger than the thickness of the core layer at the second end. For example, the thickness of the core layer at a first end of the ramp region is the first thickness, while the thickness of the core layer at the second end of the ramp region is the second thickness. For example, the thickness of the core layer may be from 150 to 300 nm at the second end of the ramp region.

The present disclosure also relates to an optical device (such as a PIC) comprising a spot size converter as described herein, wherein an optical waveguide of the optical device is (e.g., integrally) connected to the optical waveguide of the spot size converter.

Moreover, in some non-limiting embodiments, the present disclosure relates to a method of fabricating a spot size converter, as described herein, comprising the steps of
providing a substrate;
forming an optical waveguide having at least one core layer and at least a first and a second cladding layers such that
the first cladding layer is located between the substrate and the core layer and the second cladding layer is arranged on a side of the core layer facing away from the first cladding layer,
the core layer has a first thickness in a first section of the spot size converter, and
the core layer in a second section of the spot size converter has a second thickness which is smaller than the first thickness, and
forming a ramp region located between the first and the second section and in which the thickness of the core layer decreases continuously;
forming a facet via which light can be coupled into an optical device, wherein
forming a guiding structure in the core layer, the guiding structure configured to guide light laterally, wherein the guiding structure does not extend to the facet, and wherein
the core layer comprises lithium niobate or silicon nitride.

Features described above in conjunction with the spot size converter according to the present disclosure may of course be used to implement non-limiting embodiments of the methods herein.

For example, the method may comprise generating a region in which the width of the guiding structure decreases. The ramp region may be formed using a first lithography process and the guiding structure is formed using a second lithography process different from the first lithography process. As already set out above, the first lithography process may be a gray-scale lithography process. As disclosed herein, the ramp region may be generated after the first lithography process (and, e.g., removing mask material) using an etching process (e.g., a dry etching process). After the second lithography process the guiding structure is formed, e.g., by means of an etching process. The formation of the guiding structure (including performing the second lithography process) may be carried out before or after performing the process for producing the ramp region (e.g., before the first lithography process or after an etching process for forming the ramp region).

### BRIEF DESCRIPTION OF THE DRAWING

Non-limiting embodiments of the present disclosure are described hereinafter with reference to the Figure.

### DETAILED DESCRIPTION

The Figure shows a spot size converter (SSC) 1 comprising a substrate 10, which may consist of silicon and/or silicon oxide (e.g., SiO₂). Further, the SSC 1 comprises an optical waveguide 3 having a core layer 31 and a first and a second cladding layer 32, 33. The first cladding layer 32 is arranged between the substrate 10 and the core layer 31, while the second cladding layer 33 is located on top of the core layer 31, i.e., it extends on a side of the core layer 31 that faces away from substrate 10.

Further, the core layer 31 has a lower and an upper portion 310, 311 consisting of the same material such as lithium niobate or silicon nitride. A guiding structure in the form of a rib 4 is formed in the upper portion 311, wherein the lower portion 310 forms a layer or a slab waveguide that extends beyond lateral sidewalls of rib 4. The second cladding layer 33 embeds the rib 4, i.e., it extends on top of an upper surface and adjacent lateral sidewalls of rib 4. Although the second cladding 33 is shown to have a width smaller than the width of the lower portion 310 of the core layer 31, this is only optional. The second cladding layer 33 may have the same width as the lower portion 310 (or the first cladding layer 32) or may even be broader.

The SSC 1 further comprises a first and a second section 100, 200, wherein the first section 100 is in proximity of a first side 150 of SSC 1 and the second section 200 is in proximity of a second side of SSC 1 formed as an optical facet 250. The first side 150 may be (e.g., integrally) connected to an optical component such as a PIC (the optical component is not shown in the Figure). The optical facet 250 forms an output of the SSC 1 via which light may exit the SCC 1 and may be coupled into an optical device such as an optical fiber (also not shown in the Figure).

The thickness of core layer 31 in the first section 100 is larger than the thickness of the core layer 31 in the second section 200, wherein a ramp region 400 extends between the first and the second section 100, 200. The thickness is measured perpendicular to the main extension direction of substrate 10 and relates to the total thickness of core layer 31, i.e., the sum of the thickness of the lower portion 310 and the thickness of the upper portion 311. The thickness of the core layer 31 decreases continuously over the ramp region 400, wherein the thickness of the core layer 31 at a first end 401 of the ramp region 400 corresponds to its thickness in the first section 100, while the thickness of the core layer 31 at a second end 402 of the ramp region 400 corresponds to its thickness in the second section 200. The width of the rib 4 is constant over the entire ramp region 400. However, according to some non-limiting embodiments, the width of the rib 4 is constant only across a portion of the ramp region 400.

The ramp region 400 is essentially formed by a decrease of the thickness of the lower portion 310 of core layer 31, while the height of the rib 4 is kept essentially constant. However, it is also possible that the height of the rib 4 is reduced over the ramp region 400. At the second end 402 of the ramp region 400 the core layer 31 is completely removed outside the rib 4. However, the complete removal of the core layer 31 adjacent the rib 4 is only optional. It is also possible that the thickness of the lower portion 310 is reduced without completely removing it.

The optical waveguide 3 further comprises a laterally tapered region 500 between the ramp region 400 and the facet 250 in which the width of the rib 4 decreases. It is possible that the region 500 does not extend over the entire section between the ramp region 400 and the facet 250. Rather, the waveguide 3 may comprise a section of constant width, that section being arranged, e.g., between the ramp region 400 and the laterally tapered region 500 and/or between the facet 250 and the laterally tapered region 500.

The reduction of the thickness of the waveguide core layer 31 and of the width of the rib 4, i.e., the vertical and lateral tapering of the waveguide core layer 31, weakens the confinement of a mode guided by the waveguide 3. This weakened confinement results in an expanding mode size towards the facet 250, which permits an efficient coupling to an optical device via the facet 250 as set out above.

1. A size converter for adapting at least one of the diameter and the shape of a mode field of an optical component, comprising
a substrate;
an optical waveguide comprising at least one core layer and at least a first cladding layer and at least a second cladding layer, wherein
the first cladding layer is located between the substrate and the core layer, while the second cladding layer is arranged on a side of the core layer facing away from the first cladding layer;
a first section in which the core layer has a first thickness; and
a second section in which the core layer has a second thickness which is smaller than the first thickness;
a ramp region located between the first section and the second section and in which the thickness of the core layer decreases continuously;
a facet via which light can be coupled into an optical device, wherein
the core layer comprises a guiding structure configured to guide light laterally, wherein the guiding structure does not extend to the facet, and wherein
the core layer comprises lithium niobate or silicon nitride.

2. The spot size converter of claim 1, wherein the guiding structure comprises or consists of a rib.

3. The spot size converter of claim 1, further comprising a region in which the width of the guiding structure decreases.

4. The spot size converter of claim 3, wherein the region in which the width of the guiding structure decreases and overlaps at least partially with the ramp region.

5. The spot size converter of claim 1, wherein the width of the guiding structure is constant over at least a portion of the ramp region or over at least the entire ramp region.

6. The spot size converter of claim 1, wherein the shape of the guiding structure in the first section is different from the shape of the guiding structure in the second section.

7. The spot size converter of claim 3, wherein the region in which the width of the guiding structure decreases extends to the facet.

8. The spot size converter of claim 3, wherein the guiding structure has a portion in which its width is essentially constant, said portion being located between the facet and the region in which the width of the guiding structure decreases.

9. The spot size converter of claim 1, wherein the core layer at least in a region between the ramp region and the facet is removed outside the guiding structure such that a height of the guiding structure corresponds to the thickness of the core layer.

10. The spot size converter of claim 1, wherein the first cladding layer is formed by a buried oxide layer.

11. The spot size converter of claim 1, wherein the first and the second cladding layer each have a refractive index that is lower than the refractive index of the core layer.

12. An optical device comprising a spot size converter of claim 1, wherein an optical waveguide of the optical device is connected to the optical waveguide of the spot size converter.

13. A method of fabricating a spot size converter comprising:
providing a substrate;
forming an optical waveguide having at least one core layer and at least a first cladding layer and a second cladding layer such that
the first cladding layer is located between the substrate and the core layer and the second cladding layer is arranged on a side of the core layer facing away from the first cladding layer,
the core layer has a first thickness in a first section of the spot size converter, and
the core layer in a second section of the spot size converter has a second thickness which is smaller than the first thickness;
forming a ramp region located between the first and the second section and in which the thickness of the core layer decreases continuously,
forming a facet via which light can be coupled into an optical device, wherein
forming a guiding structure in the core layer, the guiding structure configured to guide light laterally, wherein the guiding structure does not extend to the facet, and wherein
the core layer comprises lithium niobate or silicon nitride.

14. The method of claim 13, further comprising generating a region in which the width of the guiding structure decreases.

15. The method of claim 13, wherein the ramp region is formed using a first lithography process and the guiding structure is formed using a second lithography process different from the first lithography process.
